(19) United States
(12) Patent Application Publication
(10) Pub. No.: US 2014/0353083 A1
(43) Pub. Date: Dec. 4, 2014

(54) WALKWAY SYSTEM FOR MACHINE

(71) Applicant: Caterpillar Inc., Peoria, IL (US)

(72) Inventors: Samson Samuel, Kollam (IN); Iyyappan Rajamoni, Kanyakurami (IN); Rajarajan Seshachalam, Chennai (IN); Mathankumar Gunasekaran, Chennai (IN)

(73) Assignee: Caterpillar Inc., Peoria, IL (US)

(21) Appl. No.: 14/459,323

(22) Filed: Aug. 14, 2014

(51) Int. Cl. E04G 5/14; B62D 63/04

(52) U.S. Cl. CPC E04G 5/14; B62D 63/04
USPC 182/87

(57) ABSTRACT

A walkway system for a machine having an operator cabin includes a first walkway, a second walkway, a first handrail, a second handrail and a reinforcing member that is coupled to lower surfaces of the first and second walkways. The first walkway is coupled to a frame of the cabin. The first walkway has a first end and a second end. The first end is positioned adjacent to the cabin. The second walkway is stationary relative to the frame. The second walkway is positioned opposite to an entrance of the cabin and adjacent to the second end. The first handrail member is disposed opposite to the entrance and coupled to the second walkway. The second handrail member is disposed between the first handrail member and the cabin, and is coupled to at least the first walkway.

### TECHNICAL FIELD

The present disclosure relates to a walkway system for a machine, and more specifically to the walkway system including a handrail.

### BACKGROUND

Machines such as, a mining truck may include an operator cabin. A platform may be provided adjacent to the cabin so that an operator may access the cabin. In some cases, these platforms may provide limited space for movement of the operator adjacent to the cabin. Moreover, it may be inconvenient for the operator to perform activities that are required in the vicinity of the cabin. For example, it may be cumbersome to accomplish cleaning of a window on a door of the cabin or a mirror that may be associated with the cabin or servicing of other components disposed in the vicinity of the cabin.

For reference, U.S. Pat. No. 6,068,277 discloses an access platform system for an earth-moving machine. The access platform system includes a first deck structure, stairs, and a second deck structure. The first deck structure includes deck members adapted to move between an upright storage position and a flat deployed position. The first deck structure also includes a deck member that is adapted to extend along the frame adjacent to an engine compartment. The stairs provide access for personnel from ground level to the first deck structure and associated safety barriers. The second deck structure is interposed between the stairs and the first deck structure. The second deck structure may be mounted on a suspension beam of the machine to move in cooperation with one or more ground engaging drive members of the machine.

### SUMMARY OF THE DISCLOSURE

In one aspect of the present disclosure, a walkway system for a machine includes a first walkway, a second walkway, a first handrail, a second handrail and a reinforcing member. The first walkway is coupled to a frame of the operator cabin. Further, the first walkway has a first end and a second end. The first end is positioned adjacent to the operator cabin. The second walkway is stationary relative to the frame of the operator cabin. The second walkway is positioned opposite to an entrance of the operator cabin and adjacent to the second end of the first walkway. A total width of the first walkway and the second walkway is at least greater than a width of the entrance. The first handrail member is disposed opposite to the entrance of the operator cabin and is coupled to the second walkway. The second handrail member is disposed between the first handrail member and the operator cabin. Moreover, the second handrail member is coupled to at least the first walkway. The reinforcing member is coupled to a lower surface of the first walkway and a lower surface of the second walkway.

Other features and aspects of this disclosure will be apparent from the following description and the accompanying drawings.

### BRIEF DESCRIPTION OF THE DRAWINGS

FIG. 1 is a perspective view of an exemplary machine, according to an embodiment of the present disclosure

FIG. 2 is a perspective view of an operator cabin of the machine showing a walkway system, according to an embodiment of the present disclosure;

FIG. 3 is a top perspective view of the walkway system, according to an embodiment of the present disclosure; and

FIG. 4 is a bottom perspective view of the walkway system showing a first reinforcing member and a second reinforcing member, according to an embodiment of the present disclosure.

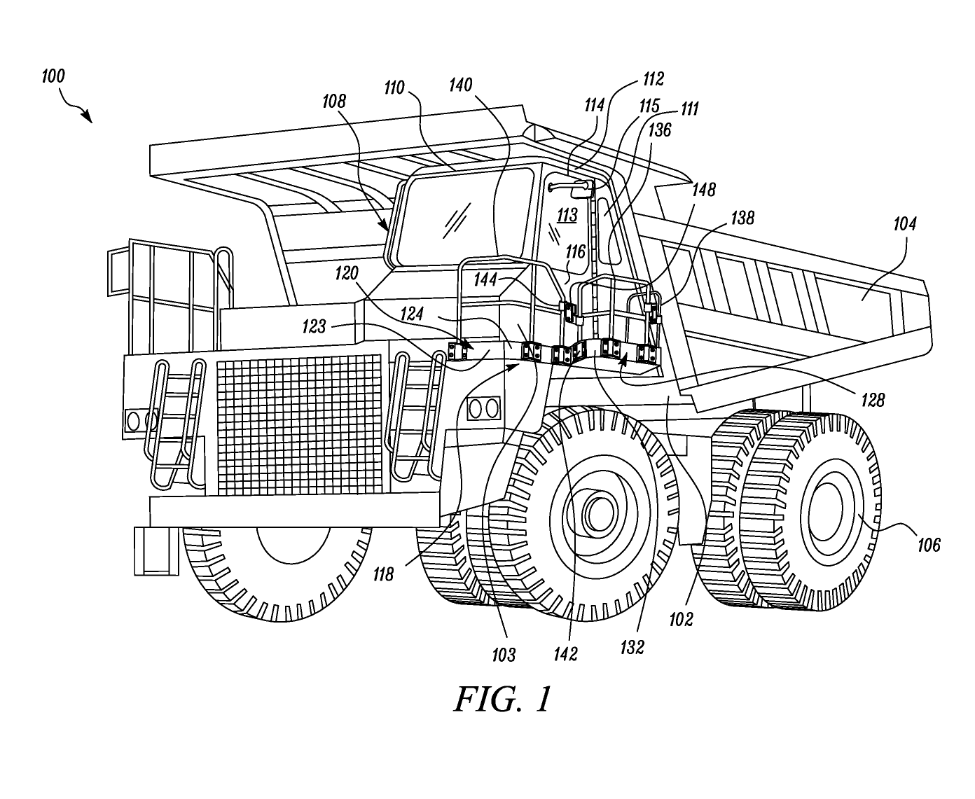

### DETAILED DESCRIPTION

Wherever possible, the same reference numbers will be used throughout the drawings to refer to the same or the like parts. FIG. 1 illustrates an exemplary embodiment of a machine 100. The machine 100 may be a mining truck. Although a mining truck is disclosed, it should be noted that the machine 100 may alternatively be embodied in the form of a haul truck, an articulated truck, an off-highway truck or other suitable machines typically employed in applications such as mining, forestry, waste management, construction, agriculture, etc.

The machine 100 may include a machine frame 102. The machine frame 102 may be configured to provide support to various components such as, but not limited to, an engine (not shown), a dump body 104, and a plurality of ground-engaging members 106. Moreover, the machine frame 102 may be configured to pivotally support the dump body 104 thereon.

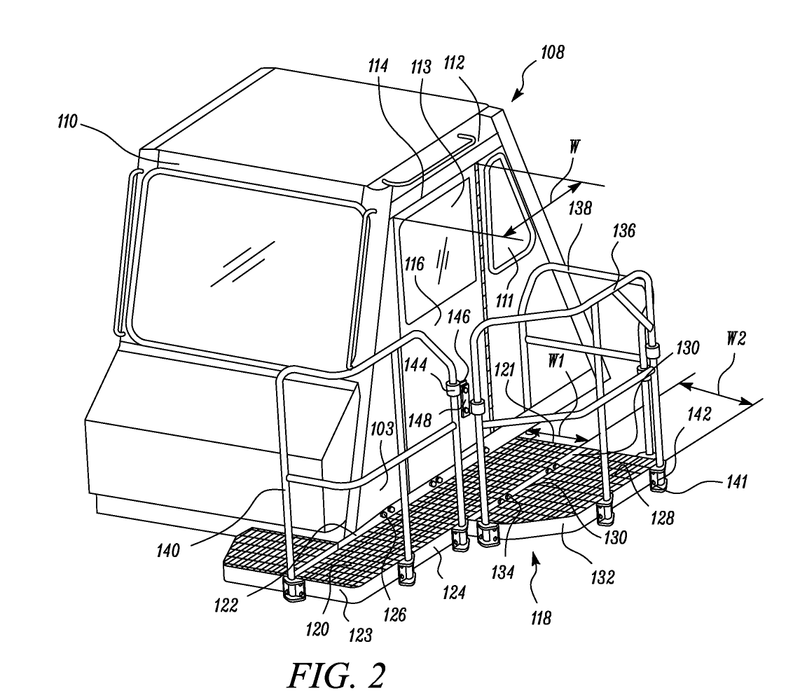

Referring to FIGS. 1 and 2, the machine 100 also includes an operator cabin 108 (hereinafter referred to as the cabin 108) which is disposed on the machine frame 102. Moreover, a frame 103 of the cabin 108 may be coupled to the machine frame 102. The cabin 108 may be configured to house components such as, but not limited to, a seat, a steering wheel (not shown) and other operator input devices that may be useful to an operator in operating the machine 100. The cabin 108 may also include sidewalls (two sidewalls 110, 112 shown in the diagrammatic illustration of FIG. 2) that may be provided with a rear window 111 and a minor 115 (See FIG. 1). Some of the components such as, the mirror 115 are not shown in FIG. 2 for illustration purposes.

Further, the sidewall 112 defines an entrance 114 having a width W. A movable door 116 may be disposed in the entrance 114. The door 116 may be hingedly mounted to an edge of the sidewall 112 and may be configured to provide access and egress of an operator or service personnel. The door 116 may include a window 113 as shown in FIG. 1.

A walkway system 118 is provided towards an exterior of the cabin 108 to allow an operator or service personnel to access the cabin 108. As shown in FIG. 2, the walkway system 118 includes a first walkway 120 and a second walkway 128. The first walkway 120 is positioned adjacent to the entrance 114 and coupled to the frame 103 of the cabin 108. In the illustrated embodiment, the first walkway 120 has a meshed configuration. Alternatively, the first walkway 120 may have a plate like configuration. The first walkway 120 is shown having a substantially rectangular shape that defines a width W1 along a first side 121 and a second side 123.

The first walkway 120 also includes a first end 122 and a second end 124 that extend downwardly from opposing edges of the first walkway 120. The first end 122 is positioned adjacent to the entrance 114. Further, the first end 122 is coupled to the cabin 108 at a position located below the entrance 114. In the illustrated embodiment, the first end 122 is coupled through multiple bolts 126 (See FIG. 2) and associated washers (not shown). The bolts 126 and the washers may be of sufficient thickness, length and/or strength so as to support the walkway system 118 on the machine 100. However, it may be contemplated to use other suitable mechanisms for the coupling. Alternatively, the first walkway 120 may be coupled to the cabin 108 by methods such as, but not limited to, welding, soldering, or by other methods commonly known to one ordinarily skilled in the art.

The second walkway 128 is positioned opposite to the entrance 114 and is configured to remain stationary in relation to the frame 103. As shown in FIG. 2, the second walkway 128 includes an inner end 130 and an outer end 132. The inner end 130 is positioned adjacent to the second end 124 of the first walkway 120.

In the illustrated embodiment, the second walkway 128 has a substantially polygonal configuration defining a width W2 (shown in FIG. 2). The second walkway 128 may be positioned so as to lie substantially co-planar relative to the first walkway 120. Further, a sum of the widths W1 and W2 of the first walkway 120 and the second walkway 128 is at least greater than the width W of the entrance 114. With such a configuration, the first walkway 120 and the second walkway 128 may together provide adequate space for movement of the door 116.

In the illustrated embodiment of FIG. 2, the inner end 130 of the second walkway 128 is coupled to the second end 124 in a threaded engagement with the help of multiple bolts 134. However, a person of ordinary skill in the art will acknowledge that the second walkway 128 and the first walkway 120 may be coupled to each other by other methods such as, but not limited to, welding, soldering, brazing and the like. Moreover, the second walkway 128 may be, additionally or optionally, coupled to the frame 103 of the cabin 108.

As illustrated, the second walkway 128 may be of a meshed configuration to represent or provide a unified structure together with the first walkway 120. Alternatively, the second walkway 128 may have a plate like configuration. However, it may be contemplated to form the first walkway 120 and the second walkway 128 with other configurations as known to one ordinarily skilled in the art.

Although, rectangular and polygonal shapes are illustrated for the first walkway 120 and the second walkway 128, respectively, a person of ordinary skill in the art will acknowledge that a shape and/or size of the first walkway 120 and the second walkway 128 may vary depending on a type of machine, cabin, door and the like.

The walkway system 118 may further include a first handrail member 136, a second handrail member 138, and a third handrail member 140. Each of the handrail members 136, 138, 140 may be located around the cabin 108 and disposed in an upright position.

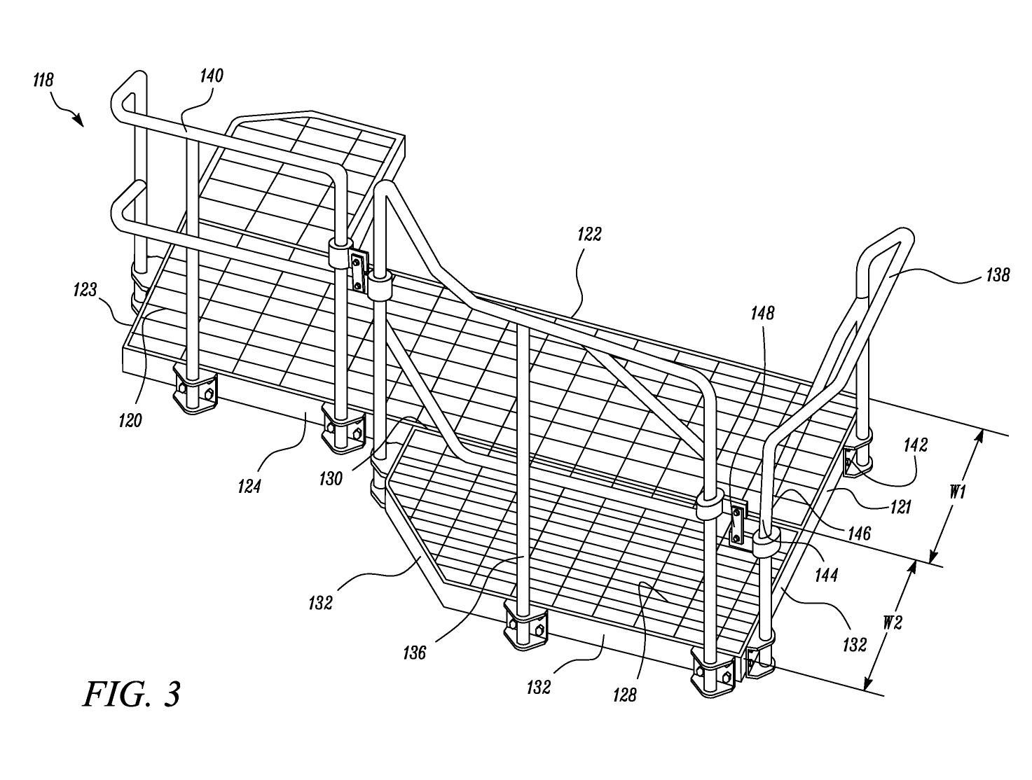

In the illustrated embodiment of FIG. 3, the first handrail member 136 is disposed opposite to the entrance 114 and adjacent to the second walkway 128. The first handrail member 136 is coupled to the outer end 132 of the second walkway 128. The second handrail member 138 is disposed between the first handrail member 136 and the cabin 108. The second handrail member 138 is positioned adjacent to the first side 121 of the first walkway 120 and coupled to at least the first walkway 120. The third handrail member 140 is disposed adjacent to the second end 124 and the second side 123 of the first walkway 120. The third handrail member 140 is coupled to at least the first walkway 120.

The coupling of the first, second and the third handrail members 136, 138 and 140 with the corresponding first and second walkways 120, 128 may be accomplished by affixing tubular portions of the first, second and third handrail members 136, 138 and 140 to corresponding support members 142. The support members 142 are fastened to the first and second walkways 120, 128 via bolts 141. However, it may be contemplated to use other suitable mechanisms for the coupling. Alternatively, the handrail members 136, 138 and 140 may be coupled to the first and second walkways 120, 128 by methods such as, welding, soldering and the like. In another embodiment, at least one of the first, second and third handrail members 136, 138 and 140 and the corresponding first and second walkways 120, 128 may be manufactured as a unitary component. Alternatively, the second handrail member 138 and at least one of the first and third handrail members 136, 140 may be integrally formed so as to present a unified or single handrail that may be coupled to the first walkway 120 and the second walkway 128.

A person of ordinary skill in the art will acknowledge that a size and shape of the handrail members 136, 138 and 140 are exemplary and hence non-limiting of this disclosure. The coupling of the handrail members 136, 138 and 140 to the first walkway 120, the second walkway 128 or both may depend on relative configurations, shapes and/or sizes of the handrail members 136, 138 and 140.

Referring to FIGS. 2 and 3, each of the first, second and third handrail members 136, 138, 140 may have sleeve members 144. In an example, the sleeve members 144 are made of metal in P-shaped clips. In an embodiment, an elastomeric member 146, for example, a hollow cylindrical shaped rubber grommet with a straight slit from external surface to an internal surface and parallel to an axis of the elastomeric member 146, may be disposed between the sleeve members 144 and the corresponding handrail members 136, 138, 140. Further, the internal surface of the elastomeric member 146 may be overlaid over the corresponding handrail members 136, 138, 140 and, an inner surface of a hoop of the sleeve member 144 may be overlaid over the external surface of the elastomeric member 146. In another embodiment, the elastomeric member 146 may be made of a two-piece semi hollow cylindrical parts, that can be attached together to form a cylindrical shaped grommet The elastomeric member 146 would be tightly held within the sleeve member 144 and over the corresponding handrail members 136, 138, 140. Further, the elastomeric member 146 and the sleeve member 144 may cooperate to minimize vibrations.

The first handrail member 136 may be coupled to at least one of the second handrail member 138 and the third handrail member 140. In the illustrated embodiment, a connecting member 148 is bolted to the corresponding sleeve members 144 to accomplish the coupling. Coupling the handrail members 136, 138, 140 to each other may minimize relative movement therebetween.

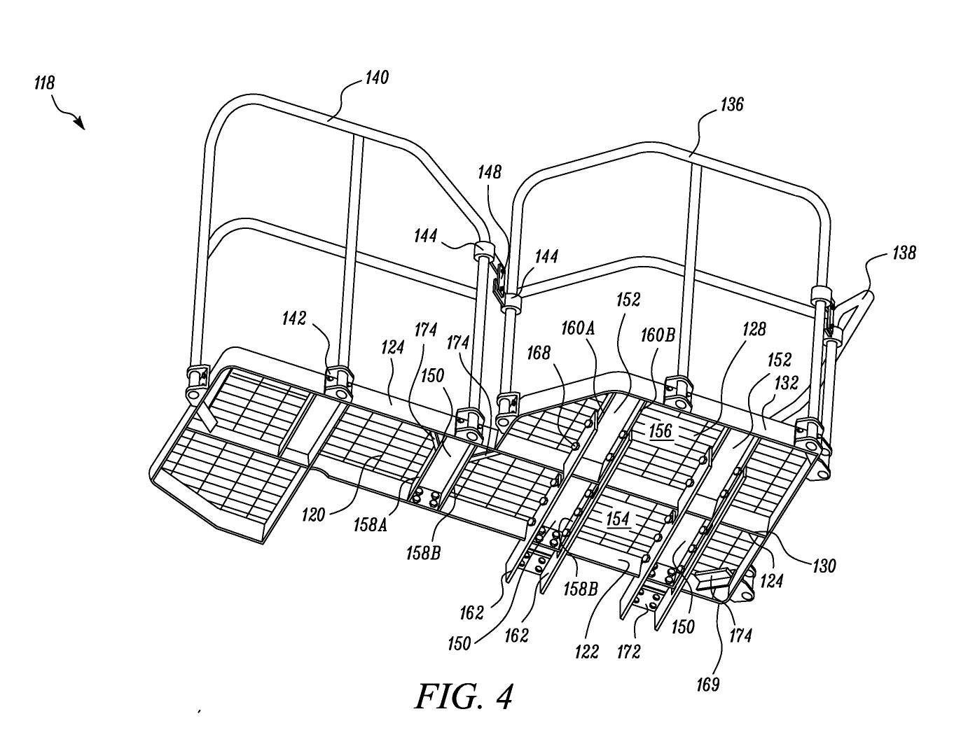

Referring to FIG. 4, each of the first walkway 120 and the second walkway 128 include cross-bars 150, 152. The cross-bars 150, 152 are laterally disposed on lower surfaces 154, 156 of the first walkway 120 and the second walkway 128, respectively. The cross-bars 150, 152 may be substantially C-shaped that has lateral sides 158A, 158B and 160A, 160B respectively. The lateral sides 158A, 158B and 160A, 160B may define multiple apertures (not shown) therein. The first walkway 120 and the second walkway 128 may be assembled such that at least one or more of the associated cross-bars 150, 152 are axially aligned with each other.

Each of such axially aligned cross-bars 150, 152 may be coupled to first reinforcing members 162. In the illustrated embodiment, each of the axially aligned cross-bars 150 and 152 may be provided with two of the first reinforcing members 162 that may be coupled to the corresponding lateral sides 158A, 160A and 158B, 160B, respectively. The first reinforcing member 162 may have a planar configuration that defines slots (not shown) configured to be axially aligned with the corresponding apertures defined by the lateral sides 158A, 160A or 158B, 160B. The first reinforcing members 162 may be coupled to the corresponding lateral sides 158A, 160A or 158B, 160B using bolts 168 that are inserted through the axially aligned slots of the first reinforcing members 162 and apertures of the corresponding lateral sides 158A, 160A or 158B, 160B. Moreover, the first reinforcing member 162 may define an opening to partly receive the second end 124 of the first walkway 120 and the inner end 130 of the second walkway 128.

In an embodiment, the first reinforcing members 162 may extend out of the first end 122 of the first walkway 120. In such a case, an extension member 172 (see FIG. 4) may be coupled to a top ends of both the first reinforcing members 162 that are coupled to the cross-bars 150, 152. The extension member 172 may also be coupled to the cabin 108.

The walkway system 118 may also include second reinforcing members 174 coupled to lower surfaces 154, 156 of the first walkway 120 and the second walkway 128. As shown in FIG. 4, the second reinforcing members 174 may be coupled to corners 169 adjacent to which the handrail members 136, 138 and 140 are coupled to the first and second walkways 120, 128. In the illustrated embodiment, each of the second reinforcing members 174 are T-shaped brackets that are welded to the corresponding corners 169.

Although, the first reinforcing members 120 and the second reinforcing members 174 are described, a person of ordinary skill in the art will understand that the walkway system 118 may beneficially include other reinforcing members to provide support and/or strength to various parts of the walkway system 118.

### INDUSTRIAL APPLICABILITY

The walkway system 118 of the present disclosure is provided around the cabin 108 to allow service personnel or an operator to access to the cabin 108. Moreover, addition of the second walkway 128 to the first walkway 120 provides an extended space that is configured to allow unobstructed movement of the door 116 and movement of operator or service personnel. For example, in cold conditions, provision of the second walkway 128 may allow service personnel to perform various service routines such as, but not limited to, cleaning of the window 113 on the door 116, the rear window 111 and the mirror 115.

Additionally, the walkway system 118 includes a contiguous handrail configuration, i.e., the first, second and the third handrail members 136, 138 and 140 disposed around the first and second walkways 120, 128. As such, the walkway system 118 may provide convenience to service personnel while performing service routines.

Further, it is envisioned that the sizes of the first walkway 120 and the second walkway 128 may be selected so as to comply with industrial standards and regulatory requirements. A design of the walkway system 118 disclosed herein is simple, and hence, may be easily manufactured for fitment onto the machine 100. Moreover, the simple design of the walkway system 118 may allow one to retrofit the walkway system 118 onto existing machines with or without substantial modifications to the machine 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A walkway system for a machine having an operator cabin, the walkway system comprising:
a first walkway coupled to a frame of the operator cabin, the first walkway having a first end and a second end, the first end positioned adjacent to the operator cabin;
a second walkway stationary relative to the frame of the operator cabin, the second walkway positioned opposite to an entrance of the operator cabin and adjacent to the second end of the first walkway, wherein a sum of widths of the first walkway and the second walkway is at least greater than a width of the entrance;
a first handrail member coupled to the second walkway, the first handrail member disposed opposite to the entrance of the operator cabin;
a second handrail member disposed between the first handrail member and the operator cabin, the second handrail member coupled to at least the first walkway; and
a reinforcing member coupled to a lower surface of the first walkway and a lower surface the second walkway.
